(19) United States
(12) Patent Application Publication
(10) Pub. No.: US 2020/0325856 A1
(43) Pub. Date: Oct. 15, 2020

(54) ENGINE WITH VALVE ASSEMBLY FOR SELECTABLE EXHAUST GAS BYPASS

(71) Applicant: GM GLOBAL TECHNOLOGY OPERATIONS LLC, Detroit, MI (US)

(72) Inventors: Jianwen Li, Farmington Hills, MI (US); Michael J. Bonello, Canton, MI (US)

(21) Appl. No.: 16/383,032

(22) Filed: Apr. 12, 2019

(51) Int. Cl. F02M 26/16; F02F 1/42; F02B 37/02; F02B 37/12; F02F 1/24; F02F 1/36; F01N 13/10; F02M 26/04; F02M 26/09; F02M 26/43

(52) U.S. Cl. CPC F02M 26/16; F02F 1/4264; F02B 37/02; F02B 37/12; F02M 26/43; F02F 1/36; F01N 13/105; F02M 26/04; F02M 26/09; F02F 1/243

(57) ABSTRACT

An internal combustion engine includes a cylinder head assembly having a first group of exhaust ports and a second group of exhaust ports as well as an exhaust manifold integrated with the cylinder head assembly. The exhaust manifold includes a first runner in fluid communication with the first group of exhaust ports. The first runner defines a first exit configured for directing exhaust gas from the first group of exhaust ports to an EGR bypass passage and further defines a second exit configured for directing exhaust gas from the first group of exhaust ports to a turbocharger passage. The engine further includes a bypass valve assembly mounted to the exhaust manifold and having a bypass valve disposed within the first runner. The bypass valve is moveable between a turbine-closed position and an EGR-closed position.

### INTRODUCTION

The subject disclosure relates to an internal combustion engine having a turbocharger assembly and an exhaust gas recirculation (EGR) system including an integrated exhaust manifold with a bypass valve assembly being cooperatively configured for selectively directing exhaust gas from a dedicated EGR cylinder of the engine for exhaust gas recirculation to an intake manifold or to the turbocharger assembly for use by a turbine.

Internal combustion engines may re-circulate exhaust gas from one or more dedicated cylinders to an intake manifold, typically referred to as exhaust gas recirculation or EGR, to improve fuel efficiency of the vehicle and/or reduce engine emissions. Additionally, internal combustion engines often include a turbocharger assembly. The turbocharger assembly uses the flow of exhaust gas to spin a turbine, which in turn drives a compressor that compresses the combustion air that is supplied to the intake manifold. When the exhaust gas from a pre-determined number of the cylinders of the internal combustion engine is dedicated to the intake manifold for EGR purposes, thereby bypassing the turbocharger assembly, the flow rate of the exhaust gas available to the turbine of the turbocharger assembly is reduced, which reduces the maximum power output of the internal combustion engine.

Accordingly, it is desirable to provide an engine with an improved bypass valve assembly for use with a cylinder head assembly having an integrated exhaust manifold that is readily positioned and selectable for directing exhaust gas for recirculation or to the turbine.

### SUMMARY

In one exemplary embodiment, an internal combustion engine for a vehicle includes a cylinder head assembly having a first group of exhaust ports and a second group of exhaust ports. The engine further includes an exhaust manifold integrated with the cylinder head assembly. The exhaust manifold includes a first runner in fluid communication with the first group of exhaust ports. The first runner defines a first exit configured for directing exhaust gas from the first group of exhaust ports to an EGR bypass passage and further defines a second exit configured for directing exhaust gas from the first group of exhaust ports to a turbocharger passage. The engine further includes a bypass valve assembly mounted to the exhaust manifold and having a bypass valve disposed within the first runner. The bypass valve is moveable between a turbine-closed position and an EGR-closed position. When the bypass valve is in the turbine-closed position, it seals the second exit such that all exhaust gas from the first exhaust gas ports is directed to flow through the first exit and out the EGR bypass passage and is blocked from flowing through the second exit and the turbocharger passage. When the bypass valve in the EGR-closed position, it seals the first exit such that all exhaust gas from the first group of exhaust ports is directed to flow through the second exit and out the turbocharger passage and is blocked from flowing through the first exit and into the EGR bypass passage.

In addition to one or more of the features described herein, the exhaust manifold of the engine includes a second runner in fluid communication with the second group of exhaust ports. The second runner defines a third exit configured for directing exhaust gas from the second group of exhaust ports to the turbocharger passage.

In yet another embodiment, the second runner of the engine is in fluid communication with the second exit of the first runner. When the bypass valve is in the EGR-closed position, the exhaust gas from the first group of exhaust ports is directed out the second exit of the first runner into the second runner and then out the third exit of the second runner into the turbocharger passage such that when the bypass valve is in the EGR-closed position, all of the exhaust gas from both the first and second group of exhaust ports is directed into the turbocharger passage.

In another exemplary embodiment, the bypass valve assembly includes a rotatable shaft having a first valve seat and a second valve seat positioned on opposite sides of the shaft. The first valve seat is shaped to close the first exit when the bypass valve is in the EGR-closed position when the shaft is rotated to a first shaft position. The second valve seat is shaped to close the second exit when the bypass valve is in the turbine-closed position when the shaft is rotated to a second shaft position.

In yet another exemplary embodiment, the bypass valve assembly includes a spring attached to the shaft. The spring is configured to bias the shaft to stay in the first shaft position.

In another embodiment, the first valve seat and the second valve seat of the bypass valve are mirror images of each other.

In a further embodiment, the first valve seat has a first sealing surface shaped to seal the first exit when the bypass valve is in the EGR-closed position, and the second valve seat has a second sealing surface shaped to seal the second exit when the bypass valve is in the turbine-closed position.

In another exemplary embodiment, the bypass valve assembly includes a flange at an end of the bypass valve assembly opposite the first and second valve seats. The flange is attached to an external side of a wall of the cylinder head assembly.

In a further exemplary embodiment, the bypass valve assembly of the engine includes a bushing affixed in the flange. The bushing has an axially extending shaft opening and circumferentially surrounds the shaft such that the shaft is smoothly rotatable relative to the bushing and flange.

In another embodiment, the bypass valve assembly includes an arm extending radially outward from the shaft. The first and second valve seats are attached to the arm.

In another exemplary embodiment, the bypass valve is primarily disposed within a recess of the first runner.

In yet another exemplary embodiment, the first and second valve seats are entirely disposed within a recess of the first runner of the engine.

In another exemplary embodiment, an internal combustion engine for a vehicle includes a cylinder head assembly defining a first group of exhaust ports and a second group of exhaust ports. An exhaust manifold is integrally formed with the cylinder head assembly. A first runner is defined in the exhaust manifold in fluid communication with the first group of exhaust ports. The first runner defines a first exit configured for directing exhaust gas from the first group of exhaust ports to an EGR bypass passage. The first runner further defines a second exit configured for directing exhaust gas from the first group of exhaust ports to a turbocharger passage. A second runner is in fluid communication with the second group of exhaust ports and in fluid communication with the first runner through the second exit. The second runner defines a third exit configured for directing exhaust gas from the second group of exhaust ports to the turbocharger passage. The second runner is in fluid communication with the second exit of the first runner. A bypass valve assembly is disposed within the first runner and moveable between a first position wherein the first exit is open and the second exit is closed, and a second position wherein the first exit is closed and the second exit is open. When the bypass valve assembly is in the first position, the exhaust gas from the first group of exhaust ports is entirely directed out the first exit of the first runner into the EGR bypass passage. When the bypass valve assembly is in the second position then the exhaust gas from the first group of exhaust ports is entirely directed out the second exit of the first runner into the turbocharger passage.

In addition to one or more other features described herein, the bypass valve assembly has an end attached to a wall of the cylinder head assembly and a portion of the bypass valve assembly extends into and is disposed in the first runner.

In yet another exemplary embodiment, the bypass valve assembly is a rotatable flap assembly having a first valve seat shaped for sealingly closing the first exit and a second valve seat shaped for sealingly closing the second exit.

In a further embodiment, the bypass valve assembly includes a spring that manually biases the bypass valve assembly to the second position.

In a further exemplary embodiment, a method of selectively defining a dedicated exhaust gas recirculation system for an engine having a turbocharger assembly includes providing a cylinder head assembly having a first group of exhaust ports in fluid communication with a first cylinder and a first runner, providing a second group of exhaust ports in fluid communication with a second cylinder and a second runner, providing a first exit in the first runner in fluid communication with the first group of exhaust ports and an EGR bypass passage and providing a second exit in the first runner in fluid communication with the first group of exhaust ports and with the second runner, and providing a second runner having a third exit in fluid communication with a turbocharger passage leading to the turbocharger assembly. The method further includes providing an exhaust bypass valve disposed in the first runner and moveable between a turbine-closed position wherein the second exit is closed and the first exit is open and all exhaust gas from the first group of exhaust gas ports is directed through the EGR bypass passage to create a dedicated EGR system using the first cylinder, and an EGR-closed position wherein the first exit is closed and the second exit is open and all exhaust gas from the first group of exhaust ports is directed through the second exit into the second runner and joins the exhaust gas from the second group of exhaust ports and exits out the third exit into the turbocharger passage such that all of the exhaust gas flow is used to power the turbocharger assembly.

In addition to one or more features described herein, the method further includes a step of selectively actuating the bypass valve assembly between the turbine-closed position and the EGR-closed position based on determining desired operating parameters of the engine.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic perspective view of a portion of an internal combustion engine;

FIG. 2A is a cross-sectional view along line 2A-2A of FIG. 1 showing an engine with a bypass valve assembly in an EGR-closed position;

FIG. 2B is a cross-sectional view along line 2A-2A of FIG. 1 showing an engine with a bypass valve assembly in a turbine-closed position;

FIG. 3 is a cross-sectional view along line B-B of FIG. 2 showing an engine with a bypass valve assembly; and

FIG. 4 is a perspective view of the bypass valve assembly without a flange thereon.

### DETAILED DESCRIPTION

The following description is merely exemplary in nature and is not intended to limit the present disclosure, its application or uses. It should be understood that throughout the drawings, corresponding reference numerals indicate like or corresponding parts and features. Those having ordinary skill in the art will recognize that terms such as “above,” “below,” “upward,” “downward,” “top,” “bottom,” etc., are used descriptively for the figures, and do not represent limitations on the scope of the invention, as defined by the appended claims

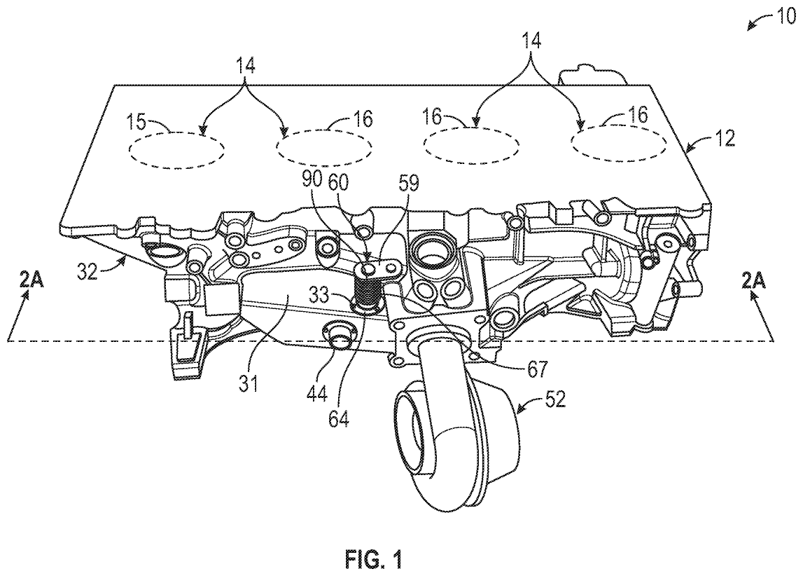

In accordance with an exemplary embodiment, an internal combustion engine is generally shown at 10 in FIG. 1. The internal combustion engine 10 may include, but is not limited to, a diesel engine or a gasoline engine. The internal combustion engine 10 includes an in-line four-cylinder gasoline engine. However, it should be appreciated that the internal combustion engine 10 may include any suitable size and/or configuration of engine, including but not limited to an in-line six-cylinder engine, a v-style six-cylinder engine, or a v-style eight-cylinder engine. As shown in this exemplary embodiment, the engine 10 is a gasoline engine with four in-line cylinders 14.

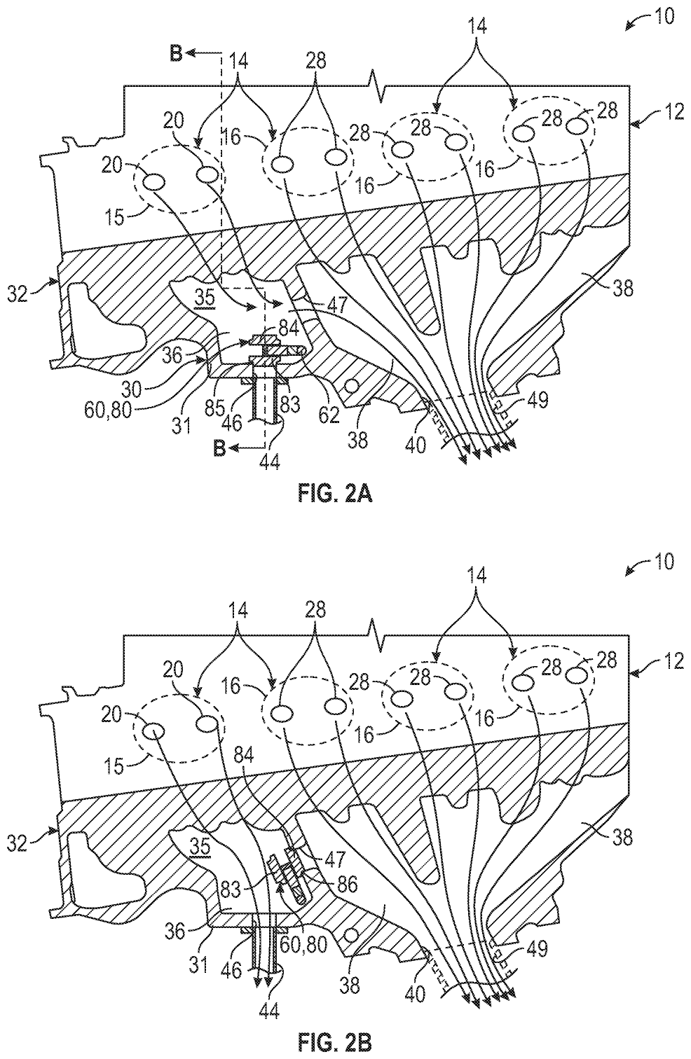

Referring to FIGS. 1, 2A, and 2B, the internal combustion engine 10 includes a cylinder head assembly 12. The cylinder head assembly 12 is attached to a block (not shown) and may be made of a suitable metal material, such as aluminum. As is known, the block defines a plurality of cylinders 14. The cylinder head assembly 12 defines a plurality of exhaust ports 20, 28, with the exhaust ports 20, 28 in fluid communication with the cylinders 14 of the block for discharging exhaust gas after combustion. The plurality of exhaust ports includes a first group of exhaust ports 20 associated with a first cylinder 15 and a second group of exhaust ports 28 associated with a second group of cylinders 16.

Referring to FIGS. 2A and 2B, the first group of exhaust ports 20 and the second group of exhaust ports 28 may each include a pre-defined number of exhaust ports. As the internal combustion engine depicted includes four in-line cylinders 14, the total number of exhaust ports is equal to eight to correspond with two exhaust ports 20 for the first cylinder 15 and two exhaust ports 28 for each of the three remaining cylinders in the second group of cylinders 16. While two exhaust ports 20, 28 per cylinder 14 are shown in this engine 10, it will be appreciated that that there could be one or more exhaust ports 20 associated with first cylinder 15 and one or more exhaust ports 28 associated with each of the second group of cylinders 16.

The first group of exhaust ports 20 may be referred to as Exhaust Gas Recirculation (EGR) exhaust ports 20, as the exhaust gas discharged through the first group of exhaust ports 20 may be selectively directed to a bypass exit passage 46 that leads to an EGR bypass port 44 and further to an intake manifold (not shown) to establish a dedicated EGR system 30 for the internal combustion engine 10 using first cylinder 15, as described in greater detail herein. The second group of exhaust ports 28 may be referred to as working exhaust ports, as the exhaust gas discharged through the second group of exhaust ports 28 is directed for use to power a turbocharger assembly 52 to spin a turbine, described further herein.

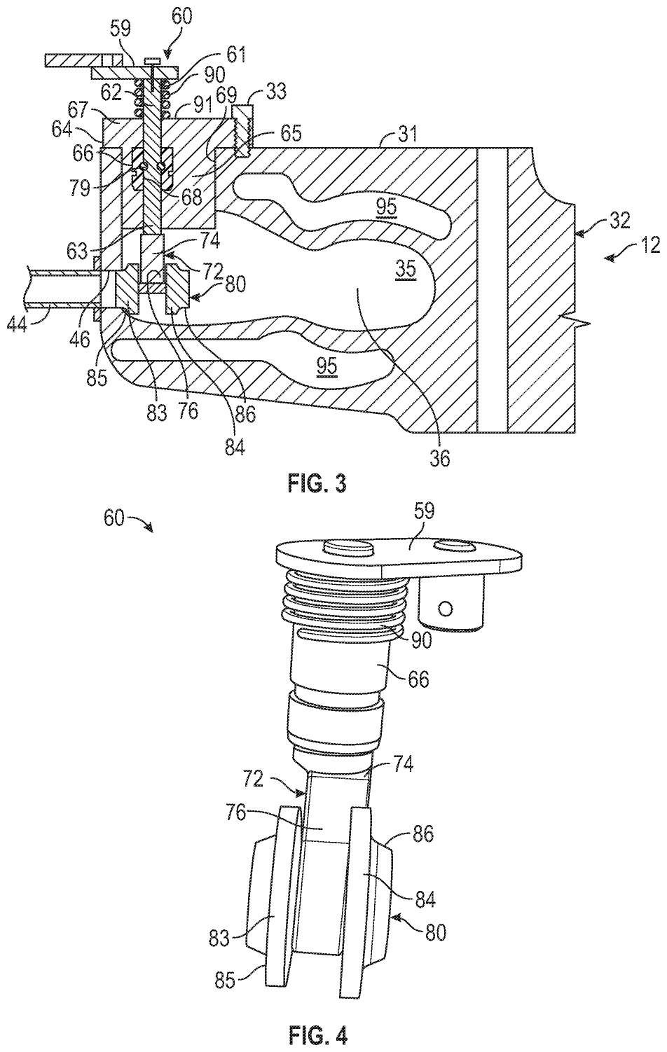

With reference to FIG. 1, the cylinder head assembly 12 includes an integrated exhaust manifold 32 being integrally formed with the cylinder head assembly 12. As shown in this exemplary embodiment, the cylinder head assembly 12 and the integrated exhaust manifold 32 are integrally cast as a single unit. However, it will be appreciated that they could be welded or otherwise affixed to each other. As shown in FIG. 3, the cylinder head assembly 12 includes water jackets or coolant passages 95 which advantageously assist in cooling a bypass valve assembly 60, as described further herein.

Referring to FIGS. 2A and 2B, the exhaust manifold 32 is configured to include a first runner 36 and a second runner or group of runners 38. It will be appreciated that while this exemplary embodiment shows the first runner 36 as a single runner and the second runner 38 as a group of runners, the runners 36, 38 may be comprised of one or more runners so long as the first and second runners 36, 38 are in fluid communication with the respective first and second groups of exhaust ports 20, 28.

The first runner 36 is in fluid communication with the first group of exhaust ports 20. The integrated exhaust manifold 32 has a first runner 36 shaped to define the bypass exit passage 46 and to further define a turbo-side exit passage 47. The turbo-side exit passage 47 is configured to be in fluid communication with the second group of runners 38 when the turbo-side exit passage 47 is open, as described further herein. Thus, it will be appreciated that when the turbo-side exit passage 47 is open, as shown in FIG. 2A, the first runner 36 is in fluid communication with the second group of runners 38. Each of the second group of runners 38 joins together to define a turbine exit passage 40 to the turbocharger assembly 52, including a turbine. The second group of runners 38 directs exhaust gas from the second group of exhaust ports 28 to the turbine exit passage 40. When the turbo-side exit passage 47 is open, the exhaust gas from the first group of exhaust ports 20 and first runner 36 is directed to flow out of the turbo-side exit passage 47 and into the second group of runners 38 and out through turbine exit passage 40 to the turbocharger assembly 52 for powering its turbine.

Referring to FIG. 2B, the first runner 36 of the exhaust manifold 32 is connected to the EGR bypass pipe or port 44 at the bypass exit passage 46. The EGR bypass port 44 is in fluid communication with the first runner 36 and the bypass exit passage 46 when the bypass valve assembly 60 is in a first turbine-closed position. When the bypass valve assembly 60 is in the first turbine-closed position, the EGR bypass port 44 is in fluid communication with the bypass exit passage 46 for discharging exhaust gas through the EGR bypass port 44 and to an intake manifold (not shown) of the engine 10. It will be appreciated that when the bypass valve assembly 60 is in the first turbine-closed position that all of the exhaust gas from the first group of exhaust ports 20 is directed through the first runner 36 and out of the bypass exit passage 46 and into the EGR bypass port 44 to the intake manifold to selectively create a dedicated EGR system 30 comprised of first cylinder 15, first runner 36, first group of exhaust ports 20, and the EGR bypass port 44 where all exhaust gas is dedicated for recirculation back to the intake manifold of the engine 10.

Referring to FIG. 2A, a turbocharger passage 49 is connected to and in fluid communication with the turbine exit passage 40 of the exhaust manifold 32 and with the turbocharger assembly 52 such that exhaust gas that flows out of the turbocharger passage 49 is directed to power the turbine of the turbocharger assembly 52. The second group of runners 38 directs exhaust gas out the turbine exit passage 40 to power the turbocharger assembly 52. As such, it will be appreciated that the all of the exhaust gas discharged through the second group of exhaust ports 28 is always directed to flow through the second group of runners 38 and out of the turbine exit passage 40 to power the turbocharger assembly 52 and its turbine.

Advantageously, when the turbo-side exit passage 47 is selectively open, when the bypass valve assembly 60 is in an EGR-closed position, then all of the exhaust gas from the first group of exhaust ports 20 is also available to power the turbocharger 52. The first runner 36 is in fluid communication with the second group of runners 38 via the turbo-side exit passage 47. As described further herein, when the turbo-side exit passage 47 is open, then the bypass valve assembly 60 is positioned to close and seal the bypass exit passage 46 wherein all exhaust gas from the first group of exhaust ports 20 and first runner 36 is directed out of the turbo-side exit passage 47 into the second group of runners 38 and then out through the turbine exit passage 40 through the turbocharger passage 49 into the turbocharger assembly 52.

As described herein, the exhaust manifold 32 further includes the bypass valve assembly 60 which is moveable between the first turbine-closed position that creates a dedicated EGR system 30 and the second EGR-closed position wherein all exhaust gas is directed to power the turbocharger assembly 52. Advantageously, movement of a single bypass valve assembly 60 creates an engine 10 that can selectively be operated with a dedicated EGR system 30 or with all exhaust gas directed to power the turbocharger assembly 52.

As shown in FIGS. 3 and 4, the bypass valve assembly 60 includes a shaft 62, a flange 64, a bushing 66, an arm 72, and a valve 80. The bypass valve assembly 60 is supported by a wall 31 of the exhaust manifold 32 and is disposed within a recess 35 of the first runner 36. As best shown in FIGS. 1 and 3, the flange 64 is fixedly attached to the wall 31 of the exhaust manifold 32, such as by a plurality of bolts 33. However, it will be appreciated that any secure method to affix the flange 64 to the wall 31 of the exhaust manifold 32, including but not limited to, welding or bonding could also be used.

Referring to FIG. 3, the shaft 62 of the bypass valve assembly 60 extends axially through and is rotatable relative to the flange 64. In this exemplary embodiment, the axially extending bushing 66 is press fit or bonded axially into a portion of the flange 64 such that the bushing 66 is fixed and does not move relative to the flange 64. The shaft 62 may be closely axially inserted through the bushing 66 for a close circumferential fit but may smoothly rotate relative to the bushing 66. In such case it will be appreciated that the bushing 66 is circumferentially positioned between the flange 64 and the shaft 62 along at least a portion of the shaft 62. It will be appreciated in this exemplary embodiment that the flange 64 and the bushing 66 are formed of separate pieces that are affixed together in a suitable manner such that the bushing 66 may be a material, such as a TPE, that is well-suited for supporting durable and smooth rotation of the shaft 62. It will further be appreciated that an o-ring 79 made of a suitable material, such as TPE that may withstand heat and rotational forces of the shaft 62, may be placed around the shaft 62 to assist with positioning the shaft 62 in the bushing 66 while permitting smooth rotation.

Referring to FIG. 3, the shaft 62 includes a valve end 63 that is affixed to an arm 72 that extends in a direction generally radially outward from the shaft 62. The arm 72 has a shaft end 74 that is fixedly attached to the shaft 62 and a valve end 76 that supports and is fixedly attached to the rotatable flap valve 80. It will be appreciated that the shaft 62, is affixed to the arm 72 which in turn is affixed to the valve 80. However, it will also be appreciated that the shaft 62, arm 72, and valve 80 could alternatively be formed from one integral piece, such as a single piece of steel, or as multiple pieces affixed, welded or bonded together.

As best shown in FIG. 4 showing the valve assembly 60 with the flange 64 removed, the valve 80 has a bypass-side valve seat 83 and associated bypass-side sealing surface 85 being shaped for closing and sealing the bypass exit passage 46. The valve 80 also has a turbo-side valve seat 84 and associated turbo-side sealing surface 86 being shaped for closing and sealing the turbo-side exit passage 47. While the valve seats 83, 84 and sealing surfaces 85, 86 are shown as being similar mirror images or each other, it will be appreciated that the valve seats 83, 84 and sealing surfaces 85, 86 could have different shapes as long as they are configured to close and seal their respective bypass exit passage 46 and turbo-side exit passage 47. It will further be appreciated that portions of the valve seats 83, 84 could be made as separate mating pieces of steel (not shown) and be inserted into the aluminum cylinder head assembly 12 around the exit passages 46, 47 for different sealing and durability options.

Advantageously, this arrangement permits use of a single bypass valve assembly 60 even if different sizes and shapes of the bypass exit passage 46 and turbine-side exit passage 47 are desired as long as the exhaust manifold 32 and first runner 36 are configured for the bypass valve assembly 60 to fit and rotate therein. It should be appreciated that the valve 80, including the valve seats 83, 84 and sealing surfaces 85, 86, may be any suitable shape and size and/or style of valve not shown or described herein that is capable of selectively opening and sealingly closing the fluid communication between the first runner 36 and the bypass exit passage 46 and the first runner 36 and the turbo-side exit passage 47.

With reference to FIGS. 1 and 3, the flange 64 of the bypass valve assembly 60 includes an axially extending portion 65 and a flange mounting portion 67. The axially extending portion 65 has a cylindrical shape with an outer diameter sized for fitting through a mounting hole 69 on the wall 31 of the exhaust manifold assembly 32 of the cylinder head assembly 12. The axially extending portion 65 of the flange 64 is smaller than the flange mounting portion 67 which has a larger diameter than the mounting hole 69 for engaging with an outer side of the wall 31 and having holes for receiving bolts 33 therethrough which may be used to attach the flange mounting portion 67 to the wall 31. The bushing 66 includes a shaft opening 68 through which the shaft 62 axially extends. It will be appreciated that the bushing 66 may be press-fitted or otherwise affixed into the axially extending portion 65 of the flange 64 such that the inserted shaft 62 extends through both the bushing 66 and the flange 64.

Referring to FIG. 3, the shaft 62 has an actuated end 61 which is fixedly attached to a link member 59 in any suitable manner such that the shaft 62 may be rotated by movement of the link member 59. The link member 59 is attached or linked either directly or indirectly through additional links or connecting components to an actuator (not shown) driven by a motor (not shown). The actuator may be any suitable type and/or style of actuator, including but not limited to a vacuum actuator, a hydraulic actuator, or an electric actuator. In response to engine control commands, messages may be sent to the motor to move the actuator and link member 59 to move and rotate the shaft 62 between the EGR-closed position and the turbine-closed position depending on the desired operating mode and conditions of the engine 10 and whether it is desirable to direct more exhaust gas to the EGR bypass port 44 or the turbocharger 52. The shaft 62 has the valve end 63 opposite the actuated end 61 which is attached to the arm 72. The arm 72 and valve 80 are fixedly attached to the shaft 62 such that the valve 80 rotates between the EGR-closed position and the turbine-closed position when the shaft 62 is rotated by link member 59.

Referring to FIGS. 3 and 4, the bypass valve assembly 60 further includes a spring 90 which is seated on an outer spring seat 91 of the flange 64. The spring 90 is disposed around the actuated end 61 of the shaft 62 between the flange 64 and the link member 59. The spring 90 is attached to the link member 59 in such a way that the spring 90 always biases the shaft 62 towards one of the closed positions. In such case, if there is otherwise a failure of the motor or actuator, then the spring 90 will manually bias the shaft 62 and thus the valve 80 towards one of the EGR-closed position or the turbine-closed position depending on the desired default operating parameters of the engine 10. In an exemplary embodiment, the spring 90 will normally bias the shaft 62 and bypass valve assembly 60 to stay in the EGR-closed position as the default when the motor or actuator are not functioning. It will be appreciated that the spring 90 avoids the undesirable situation where the bypass valve assembly 60 may otherwise be in an indeterminate intermediate position without predictable exhaust gas flow if the motor or actuator fail.

With reference to FIGS. 2A and 2B, the bypass valve assembly 60 is moveable between a first turbine-closed position shown in FIG. 2B and a second EGR-closed position shown in FIG. 2A. With reference to FIG. 2B, when the bypass valve assembly 60 is in the first turbine-closed position, then the turbo-side valve seat 84 and turbo-side sealing surface 86 of the valve 80 sealingly engage and close the turbo-side exit passage 47 of the first runner 36. As such, there is no fluid communication between the first runner 36 and the second group of runners 38 since the valve 80 with valve seat 84 and sealing surface 86 completely blocks the exhaust gas from flowing out of the turbo-side exit passage 47. In the turbine-closed position, the bypass valve assembly 60 opens the bypass exit passage 46 such that all of the exhaust gas from the first group of exhaust ports 20 is directed or forced through the recess 35 of the first runner 36 and out through the bypass exit passage 46 and into the EGR bypass port 44 leading to the intake manifold for exhaust gas recirculation. It will be appreciated that when the bypass valve assembly 60 is in this first turbine-closed position, that a dedicated cylinder EGR system 30 is selectively created using first cylinder 15 and first group of exhaust ports 20.

With reference to FIG. 2A, when the bypass valve assembly 60 is in the second EGR-closed position, then the bypass-side sealing surface 85 of the bypass-side valve seat 83 sealingly engages and closes the bypass exit passage 46 of the first runner 36. As such, there is no fluid communication between the first runner 36 and the EGR bypass port 44 since the valve 80 completely blocks the exhaust gas from flowing out of the bypass exit passage 46 thereby preventing exhaust gas recirculation. At the same time in the second EGR-closed position, the bypass valve assembly 60 opens the turbo-side exit passage 47 such that all of the exhaust gas from the first group of exhaust ports 20 is directed or forced through the first runner 36 and out of the turbo-side exit passage 47 and into the second group of runners 38. Once in the second group of runners 38, then the exhaust gas from the first group of exhaust ports 20 and first cylinder 15 combines with the exhaust gas from the second exhaust ports 20 and the second group of cylinders 16 and is directed out of the turbine exit passage 40. Thus, it will be appreciated that when the bypass valve assembly 60 is in this second EGR-closed position, all of the combined exhaust gas from all cylinders 14 and all exhaust ports 20, 28 is directed to the turbocharger passage 49 into the turbocharger assembly 52 for use by the turbine.

Advantageously, the engine 10 has a single bypass valve assembly 60 mounted on the integrated exhaust manifold 32 that is easily selectable between operating as a dedicated EGR system 30 wherein the exhaust gas from a dedicated first cylinder 15 is all directed to the EGR bypass port 44 for gas recirculation and a maximum power turbocharger system wherein the exhaust gas from all cylinders 14 and all exhaust ports 20, 28 are directed to a turbocharger assembly 52 by the use of a single rotatable bypass valve assembly 60, including flap valve 80, movable between a first turbine-closed position and a second EGR-closed position and disposed within the first runner 36.

It will further be appreciated that while the first cylinder 15 in communication with the first group of exhaust ports 20 is a single first cylinder 15 and the second group of cylinders 16 includes three cylinders in communication with the second group of exhaust ports 28, that other arrangements are possible. For example, the first cylinder could be a group of cylinders and the second cylinder could be one or more cylinders so long as the first runner includes a bypass valve assembly 60 that is selectable between the EGR-closed position and the turbine-closed position wherein the gas from the first set of exhaust ports and first cylinder or set of cylinders is directed and dedicated to the bypass exit passage 46 and exhaust gas recirculation when the bypass valve assembly 60 is in the turbine-closed position and wherein the exhaust gas from all exhaust ports 20, 28 and all cylinders 14 is directed out of the turbo-side exit passage 47 of the first runner 36 and into the second group of runners 38 and out the turbine exit passage 40 when the bypass valve assembly 60 is in the EGR-closed position such that all exhaust gas is directed to power the turbocharger assembly 52.

With reference to FIG. 3, yet another advantage of this engine 10 with bypass valve assembly 60 is that the valve 80 is disposed in the first runner 36 of the cylinder head assembly 12 and does not need additional coolant passages or plumbing compared to a traditional type of EGR valve that typically needs coolant flow passages in the valve body and around the valve seats as well as additional coolant plumbing from the engine to valve. The coolant passages 95 in the cylinder head assembly 12 can simply be extended and shaped to cool the area of the first runner 36 around the bypass valve assembly 60 that is integrated into the cylinder head assembly 12 and primarily disposed within the first runner 36.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An internal combustion engine for a vehicle, the internal combustion engine comprising:
a cylinder head assembly having a first group of exhaust ports and a second group of exhaust ports;
an exhaust manifold integrated with the cylinder head assembly, the exhaust manifold including a first runner in fluid communication with the first group of exhaust ports, the first runner defining a first exit configured for directing exhaust gas from the first group of exhaust ports to an EGR bypass passage; the first runner further defining a second exit configured for directing exhaust gas from the first group of exhaust ports to a turbocharger passage; and
a bypass valve assembly mounted to the exhaust manifold and having a bypass valve disposed within the first runner, the bypass valve being moveable between a turbine-closed position and an EGR-closed position, wherein when the bypass valve is in the turbine-closed position it seals the second exit such that all exhaust gas from the first exhaust gas ports is directed to flow through the first exit and out of the EGR bypass passage and is blocked from flowing through the second exit and the turbocharger passage, and wherein when the bypass valve in the EGR-closed position it seals the first exit such that all exhaust gas from the first group of exhaust ports is directed to flow through the second exit and out of the turbocharger passage and is blocked from flowing through the first exit and into the EGR bypass passage.

2. The engine of claim 1 where the exhaust manifold includes a second runner in fluid communication with the second group of exhaust ports, the second runner defining a third exit configured for directing exhaust gas from the second group of exhaust ports to the turbocharger passage.

3. The engine of claim 2 wherein the second runner is in fluid communication with the second exit of the first runner and wherein when the bypass valve is in the EGR-closed position, the exhaust gas from the first group of exhaust ports is directed out of the second exit of the first runner into the second runner and then out of the third exit of the second runner into the turbocharger passage such that when the bypass valve is in the EGR-closed position, all of the exhaust gas from both the first and second group of exhaust ports is directed into the turbocharger passage.

4. The engine of claim 1 wherein the bypass valve assembly includes a rotatable shaft having a first valve seat and a second valve seat positioned on opposite sides of the shaft and wherein the first valve seat is shaped to close the first exit when the bypass valve is in the EGR-closed position when the shaft is rotated to a first shaft position and wherein the second valve seat is shaped to close the second exit when the bypass valve is in the turbine-closed position when the shaft is rotated to a second shaft position.

5. The engine of claim 4 wherein the bypass valve assembly includes a spring attached to the shaft and wherein the spring is configured to bias the shaft to stay in the first shaft position.

6. The engine of claim 4 wherein the first valve seat and the second valve seat are mirror images of each other.

7. The engine of claim 4 wherein the first valve seat has a first sealing surface shaped to seal the first exit when the bypass valve is in the EGR-closed position and the second valve seat has a second sealing surface shaped to seal the second exit when the bypass valve is in the turbine-closed position.

8. The engine of claim 4 wherein the bypass valve assembly includes a flange at an end of the bypass valve assembly opposite the first and second valve seats and wherein the flange is attached to an external side of a wall of the cylinder head assembly.

9. The engine of claim 8 wherein the bypass valve assembly includes a bushing affixed in the flange, the bushing having an axially extending shaft opening and wherein the bushing circumferentially surrounds the shaft such that the shaft is smoothly rotatable relative to the bushing and flange.

10. The engine of claim 4 wherein the bypass valve assembly includes an arm extending radially outward from the shaft and wherein the first and second valve seats are attached to the arm.

11. The engine of claim 1 wherein the bypass valve assembly is primarily disposed within a recess of the first runner.

12. The engine of claim 4 wherein the first and second valve seats are entirely disposed within a recess of the first runner.

13. An internal combustion engine for a vehicle, the internal combustion engine comprising:
a cylinder head assembly defining a first group of exhaust ports and a second group of exhaust ports;
an exhaust manifold in communication with the cylinder head assembly;
a first runner defined in the exhaust manifold in fluid communication with the first group of exhaust ports, the first runner defining a first exit configured for directing exhaust gas from the first group of exhaust ports to an EGR bypass passage;
the first runner further defining a second exit configured for directing exhaust gas from the first group of exhaust ports to a turbocharger passage;
a second runner in fluid communication with the second group of exhaust ports, the second runner being in fluid communication with the first runner through the second exit, the second runner defining a third exit configured for directing exhaust gas from the second group of exhaust ports to the turbocharger passage and the second runner being in fluid communication with the second exit of the first runner;
a bypass valve assembly disposed within the first runner and moveable between a first position wherein the first exit is open and the second exit is closed and a second position wherein the first exit is closed and the second exit is open, and wherein when the bypass valve assembly is in the first position, the exhaust gas from the first group of exhaust ports is entirely directed out of the first exit of the first runner into the EGR bypass passage and wherein when the bypass valve assembly is in the second position then the exhaust gas from the first group of exhaust ports is entirely directed out of the second exit of the first runner into the turbocharger passage.

14. The engine assembly of claim 13 wherein the bypass valve assembly has an end attached to a wall of the cylinder head assembly and a portion of the bypass valve assembly extends into and is disposed in the first runner.

15. The engine assembly of claim 13 wherein the bypass valve assembly is a rotatable flap assembly having a first valve seat shaped for sealingly closing the first exit and a second valve seat shaped for sealingly closing the second exit.

16. The engine assembly of claim 13 wherein the bypass valve assembly includes a spring that manually biases the bypass valve assembly to the second position.

17. A method of selectively defining a dedicated exhaust gas recirculation system for an engine having a turbocharger assembly, the method comprising:
providing a cylinder head assembly having a first group of exhaust ports in fluid communication with a first cylinder and a first runner;
providing a second group of exhaust ports in fluid communication with a second cylinder and a second runner;
providing a first exit in the first runner in fluid communication with the first group of exhaust ports and an EGR bypass passage and providing a second exit in the first runner in fluid communication with the first group of exhaust ports and with the second runner;
providing a second runner having a third exit in fluid communication with a turbocharger passage leading to the turbocharger assembly; and
providing an exhaust bypass valve disposed in the first runner and moveable between a turbine-closed position wherein the second exit is closed and the first exit is open and all exhaust gas from the first group of exhaust gas ports is directed through the EGR bypass passage to create a dedicated EGR system using the first cylinder, and an EGR-closed position wherein the first exit is closed and the second exit is open and all exhaust gas from the first group of exhaust ports is directed through the second exit into the second runner and joins the exhaust gas from the second group of exhaust ports and exits out the third exit into the turbocharger passage wherein all of the exhaust gas flow is used to power the turbocharger assembly.

18. The method of claim 17 further comprising the step of selectively actuating the bypass valve assembly between the turbine-closed position and the EGR-closed position based on determining desired operating parameters of the engine.
